(19) United States
(12) Patent Application Publication
(10) Pub. No.: US 2011/0118898 A1
(43) Pub. Date: May 19, 2011

(54) Rehabilitation Device

(75) Inventors: Li-Chen FU, Taipei City (TW); Hung-Yu LIN, Taipei (TW); Christopher YOUNG, Taipei (TW); Jia-Yuan YU, Taipei (TW)

(73) Assignee: NATIONAL TAIWAN UNIVERSITY, TAIPEI (TW)

(21) Appl. No.: 12/703,923

(22) Filed: Feb. 11, 2010

(30) Foreign Application Priority Data
Nov. 17, 2009 (TW) TW098138965

(51) Int. Cl. G06F 17/00; A61H 3/04; G01S 3/80

(52) U.S. Cl. 701/1; 135/67; 367/118; 135/67

(57) ABSTRACT

A rehabilitation device includes a moving body, a motor, a control system and a sensor module. The moving body has a housing and a moving mechanism. The motor, disposed in the housing, connects to the moving mechanism and drives the moving mechanism. The control system is disposed in the housing and coupled to the motor. The sensor module is disposed on the moving body and coupled to the control module. The control system controls the operation of the motor to move the moving body according to information detected by the sensor module.

### CROSS REFERENCE TO RELATED APPLICATIONS

This Application claims priority of Taiwan Patent Application No. 098138965, filed on Nov. 17, 2009, the entirety of which is incorporated by reference herein.

### BACKGROUND OF THE INVENTION

1. Field of the Invention

The present invention relates to a rehabilitation device, an in particular, to a rehabilitation device functioning to assist walking.

2. Description of the Related Art

Conventional walking assistant devices comprise crutches and walkers. Users, usually use the walking assistant devices with their hands or arms for support during mobility. However, due to the manual lifting and positioning required, generally, conventional walking assistant devices are difficult for users to operate. Additionally, because conventional walking assistant devices are passive devices, application by users with special needs, such as for rehabilitation therapy after injury or surgery or assistance with walking posture, may not always be appropriate, resulting in poor results.

### BRIEF SUMMARY OF THE INVENTION

Accordingly, the present invention provides a rehabilitation device comprising a moving body, a motor, a control system and a sensor module. The moving body has a housing and a moving mechanism. The motor, disposed in the housing, connects to the moving mechanism and drives the moving mechanism. The control system is disposed in the housing and coupled to the motor. The sensor module is disposed on the moving body and coupled to the control module. The control system controls the operation of the motor to move the moving body according to information detected by the sensor module.

### BRIEF DESCRIPTION OF THE DRAWINGS

The present invention can be more fully understood by reading the subsequent detailed description and examples with references made to the accompanying drawings, wherein:

FIG. 1 is a schematic view showing a front side of the rehabilitation device of the invention;

FIG. 2 is a schematic view of the rehabilitation device in FIG. 1, wherein a housing thereof is omitted;

FIG. 3 is a schematic view showing a rear side of the rehabilitation device of the invention;

FIG. 4 is a schematic view of the rehabilitation device in FIG. 3, wherein a housing thereof is omitted.

### DETAILED DESCRIPTION OF THE INVENTION

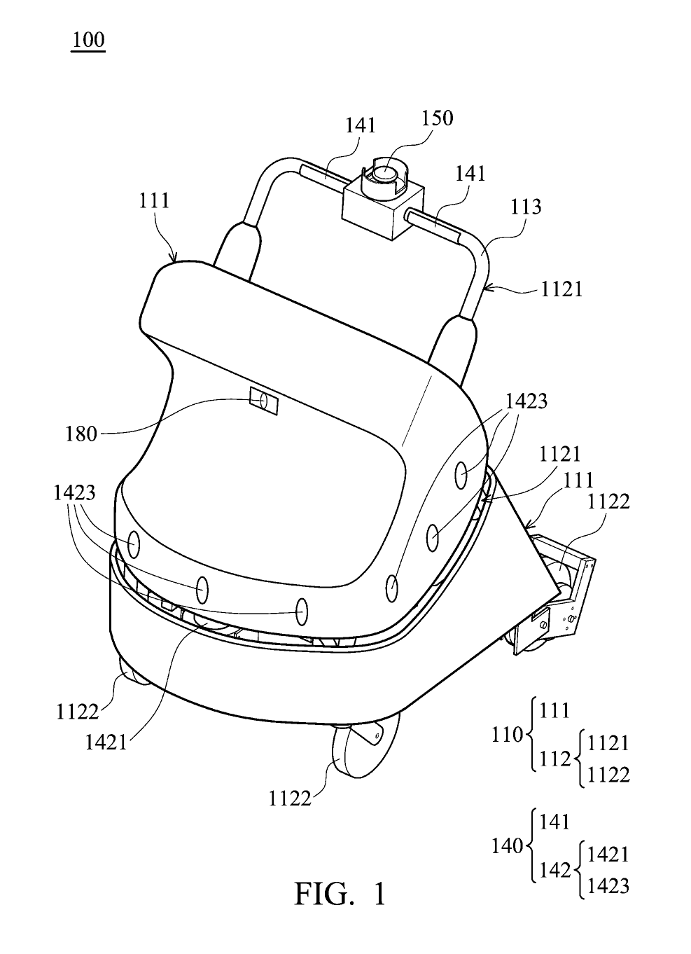

Referring to FIGS. 1 to 4, the rehabilitation device 100 of the invention may provide walking assistance for users during rehabilitation therapy. The rehabilitation device 100 comprises a moving body 100, two motors 120, a control system 130, a sensor module 140, a switch member 150, a power supply unit 160, an operating interface 170 and an illuminating apparatus 180.

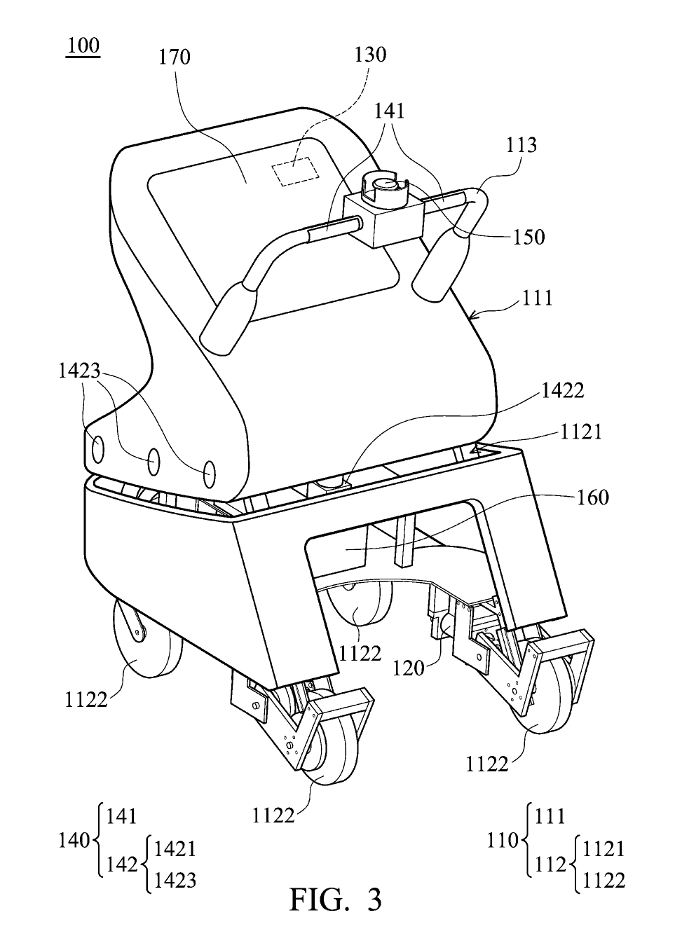

As shown in FIGS. 1 and 3, the moving body 110 comprises a housing 111 and a moving mechanism 112, wherein the moving mechanism 112 is composed of a supporting frame 1121 and a plurality of rollers 1122. The supporting frame 1121 is covered within the housing 111. The supporting frame 1121 is extended from the interior of the housing 111 to the exterior of the housing 111 to form a holding member 113. The rollers 1122 are disposed below the supporting frame 1121 in a rotatable manner to move the supporting frame 1121, such that the user may grab the holding member 113 and move with the movement of the rehabilitation device 100.

It should be noted that the embodiment the housing 111 consists of an upper housing and a lower housing for quick assembly of the power supply unit 160, but it is not limited thereto. The housing 111 can also be formed as a unitary piece.

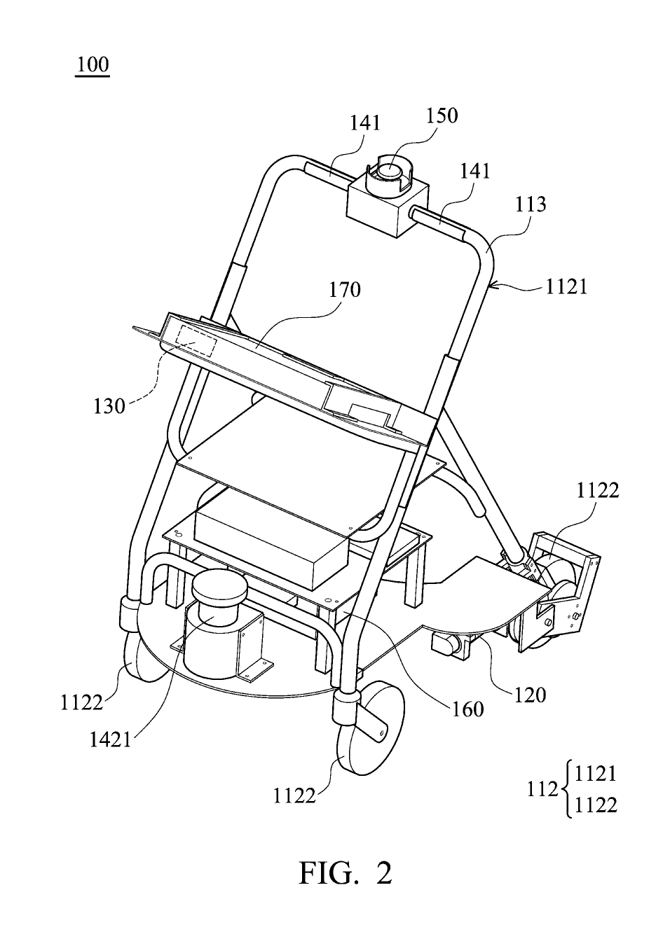

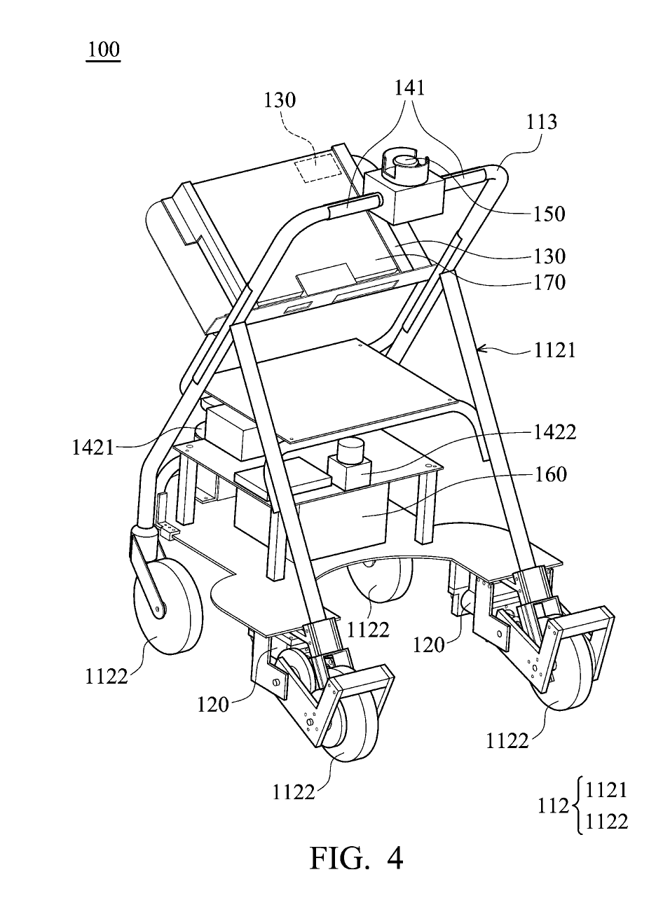

As shown in FIGS. 2 and 4, the motor 120 and the control system 130 are disposed in the housing 111. The control system 130 is coupled to the motor 120, and the motor 120 connects with the rear rollers 1122 of the moving mechanism 112. The control system 130 sends out indications to control the operation of the motor 120, thereby moving the rollers 1122 via the transmission mechanism connected to the motor 120. In addition, the control system 130 further provides signals to the transmission mechanism to allow forward movement directions, rearward movement directions and left and right movement directions. As a result, the moving body 110 is able to move toward different directions or stop according to the signals of the control system 130.

As shown in FIG. 3, the sensor module 140 is disposed on the moving body 110 and coupled to the control system 130. The control system 130 controls the operation of the motor 120 to move the moving body 110 according to the information detected by the sensor module 140. The sensor module 140 comprises a pressure sensing unit 141 and a distance sensing unit 142.

As shown in FIG. 1 to FIG. 4, the pressure sensing unit 141 comprises two pressure detectors respectively disposed on a left portion and a right portion of the holding member 113 to detect the pressure received thereon. The distance sensing unit 140 comprises a first distance sensor 1421 (as shown in FIGS. 1 and 2), a second distance sensor 1422 (as shown in FIGS. 3 and 4) and a plurality of third distance sensors (as shown in FIGS. 1 and 3). Referring to FIGS. 1 to 4 at the same time, the first distance sensor 1421 and a second distance sensor 1422, for example laser sensors, are disposed in the housing 111, and face toward the front direction and the rear direction of the moving body 110, respectively, to detect objects in front of the moving body 110 and in back of the moving body 110. Moreover, the first distance sensor 1421 transmits data of the distance between the object (front barrier) and itself to the control system 130 to help build up or amend a site map. The third distance sensors 1423, for example, ultrasound sensors, are arranged around the front side, left side and right side of the housing 111 for subtly sensing the objects at a short distance from the moving body 110.

Furthermore, the sensor module 140 may further comprises other sensing units, such as an image sensing unit and a sonic sensing unit. The image sensing unit is disposed on the front side of the moving body 110, and the image is displayed on the operating interface 170, providing blind spot vision in front of the rehabilitation device 100. The sonic sensing unit receives sound signals. Thereby, the control system 130 drives the motor 120 according to the location of the sound signals and the built-in site map and moves the rehabilitation device 100 to the sound source. Moreover, the user may send out signals to the rehabilitation device 100 via the remote controller, and the control system 130 then drives the motor 120 according to the signals and the built-in site map and moves the rehabilitation device 100 to the signal source.

As shown in FIGS. 1 to 4, the switch member 150 is disposed on the moving body 110. In this embodiment, the switch member 150 is disposed on the holding member 113 and coupled to the power supply unit 160 in the housing 111, but it is not limited thereto. The switch member 150 can be disposed on any position of the moving body 110. The switch member 150 is utilized as a protective mechanism. During emergencies, the user may press the switch member 150 to stop the operation of the rehabilitation device 100 to prevent accidents.

Referring to FIGS. 2 and 4, the power supply unit 160 is disposed in the housing 111. The power supply unit 160 is not only coupled to the switch member 150, but is also coupled to the control system 130, providing electrical power to the control system 130.

Referring to FIGS. 3 and 4, the operating interface 170, for example a touch screen display, is mounted on the supporting frame 1121 and exposed outside of the housing 111. The operating interface 170 is coupled to the control system 130. Specifically, the control system 130 and the operating interface 170 are integrated as an electronic device. In detail, the control system 130 is built with different operating modes, such as an autonomous mode and a rehabilitation mode. The user may switch freely between the autonomous mode and the rehabilitation mode, and control the operating of the sensor module 140 via the operating interface 170.

Referring to FIG. 1 again, the illuminating apparatus 180 is disposed on the front side of the housing 111, providing illumination to the users when using the rehabilitation device 100. The illuminating apparatus 180 is coupled to the power supply unit 160 and the control system 130. In other words, the user may use a switch to operating the illuminating apparatus 180, or the user may operate the illuminating apparatus 180 via the operating interface 170.

When the control system 130 is switched to the rehabilitation mode, the pressure sensing unit 141 and the distance sensing unit 142 are turned on. The user stands at the back of the rehabilitation device 100 and grabs the pressure sensing units 141 on the holding member 113 with both hands. The pressure sensing units 141 on the left side and the right side respectively send back detected pressure values to the control system 130, such that the control system 130 may determine a direction to move for the rehabilitation device 100 according to the different pressure values or the substantially same pressure values of both hands. That is, the rehabilitation device 100 turns left, turns right or moves straight according to the detected pressure values, and the degree of turning of the rehabilitation device 100 depends on the level of the pressure values.

The first distance sensor 1421 and the third distance sensor 1423 detect objects in front of the moving body 110. The control system 130 determines the distance between the rehabilitation device 100 and the objects according to the data transmitted form the first distance sensor 1421 and the third distance sensor 1423. In detail, the first distance sensor 1421 detects objects further from the rehabilitation device 100, and the third distance sensors 1423, respectively disposed on the front side, left side and right side of the housing 111, detect objects at a short distance from the rehabilitation device 100. In particular, if an object suddenly appears in the detected range of the third distance sensors 1423, the control system 130 sends out signals to make the rehabilitation device 100 stop, or to go around the object to avoid collisions. The second distance sensor 1422 is utilized to detect the distance between the user's legs and the rehabilitation device 100 and the motion of the user's legs. When the user moves forward, the second distance sensor 1422 sends the data back to the control system 130, allowing the control system 130 to move or to stop the rehabilitation device 100 accordingly. In other words, when the user moves forward one step, the rehabilitation device 100 also moves forward a distance corresponding to one step of the user. When the user stops, the rehabilitation device 100 also stops accordingly. Also, the control system 130 may further determine the moving speed of the rehabilitation device 100 according to the frequency of legs moving that is detected by the second distance sensor 1422 in order to achieve the step-by-step function.

When the control system 130 is switched to the autonomous mode, the pressure sensing unit 141 and the second distance sensor 1422 are turned off, and the first distance sensor 1421 and the third distance sensor 1423 are turned on for the rehabilitation device 100 to enter a stand by mode. When the user calls or presses the remote controller, the rehabilitation device 100 may determine the user's position and move to the signal source automatically according to the received signals. Furthermore, during automatic movement of the rehabilitation device 100, the control system 130 determines the moving direction and timely changes the moving path to avoid objects in the way of the user according to the datum from the first distance sensor 1421 and the third distance sensor 1423.

Additionally, the control system 130 is built with rehabilitation information that may be programmed by doctors concerning walking posture and duration of therapy exercises which may be displayed on the operating interface 170 as a reference for the user. Also, multi-media information is also built into the control system 130 which allows the user to play short films or play games via the operating interface 170.

In the rehabilitation device 100 of the invention, the sensor module 140 provides detected datum to allow the moving body 100 to move step by step with the user according to the physical information of the user (the holding pressure and the movement of the legs). The rehabilitation device 100 actively directs the user to perform continuous rehabilitation exercises. Meanwhile, running into objects is avoided and emergency stopping ability is provided. Thus, safety during the operation of the rehabilitation device 100 is increased. The rehabilitation device 100 of the invention provides a safe method to assist a user requiring rehabilitation. The rehabilitation device 100 of the invention helps users to speed up the rehabilitation process.

While the present invention has been described by way of example and in terms of preferred embodiment, it is to be understood that the present invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A rehabilitation device, comprising:
a moving body having a housing and a moving mechanism;
a motor disposed in the housing, connecting to the moving mechanism and driving the moving mechanism;
a control system disposed in the housing and coupled to the motor; and
a sensor module disposed on the moving body and coupled to the control module;
wherein the control system controls the operation of the motor to move the moving body according to information detected by the sensor module.

2. The rehabilitation device as claimed in claim 1, wherein the moving body further comprises a holding member disposed on a back side of the housing.

3. The rehabilitation device as claimed in claim 2, wherein the sensor module further comprises a pressure sensing unit disposed on the holding member and coupled to the control system.

4. The rehabilitation device as claimed in claim 3, wherein the pressure sensing unit comprises two pressure detectors respectively disposed on a left portion and a right portion of the holding member.

5. The rehabilitation device as claimed in claim 2, further comprising a power supply unit and a switch member, wherein the power supply unit is disposed in the housing, and the switch member, coupled to the power supply unit, is disposed on the holding member.

6. The rehabilitation device as claimed in claim 1, wherein the sensor module comprises a distance sensing unit disposed on the moving body.

7. The rehabilitation device as claimed in claim 6, wherein the distance sensing unit comprises:
a first distance sensor disposed in the housing and facing the front direction of the moving body; and
a second distance sensor disposed in the housing and facing the rear direction of the moving body.

8. The rehabilitation device as claimed in claim 7, wherein the first distance sensor and the second distance sensor are laser sensors.

9. The rehabilitation device as claimed in claim 7, wherein the distance sensing unit further comprises a plurality of third distance sensors, arranged on the front, left and right sides of the housing, respectively.

10. The rehabilitation device as claimed in claim 9, wherein the third distance sensor is an ultrasound sensor.

11. The rehabilitation device as claimed in claim 1, wherein the sensor module comprises an image sensing unit disposed on a front side of the housing.

12. The rehabilitation device as claimed in claim 1, wherein the sensor module comprises a sonic sensing unit disposed on the housing.

13. The rehabilitation device as claimed in claim 1, further comprising an operating interface disposed on the housing and coupled to the control system.

14. The rehabilitation device as claimed in claim 1, further comprising an illumination apparatus disposed on a front side of the housing and coupled to the control system.

15. The rehabilitation device as claimed in claim 1, further comprising a power supply unit disposed in the housing and coupled to the control system.

16. The rehabilitation device as claimed in claim 1, further comprising a switch member disposed on the housing and coupled to the power supply unit.

17. The rehabilitation device as claimed in claim 1, wherein the moving mechanism comprises:
a supporting frame disposed in the housing; and
a plurality of rollers connected with the supporting frame and thereby moving the supporting frame.

18. The rehabilitation device as claimed in claim 17, wherein the supporting frame is extended from an interior of the housing to an exterior of the housing to form a holding member.

19. The rehabilitation device as claimed in claim 18, wherein the sensor module comprises a pressure sensing unit disposed on the holding member and coupled to the control system.

20. The rehabilitation device as claimed in claim 19, wherein the pressure sensing unit comprises two pressure detectors respectively disposed on a left portion and a right portion of the holding member.
